(19) United States
(12) Patent Application Publication
(10) Pub. No.: US 2025/0026088 A1
(43) Pub. Date: Jan. 23, 2025

(54) METHOD FOR MANUFACTURING A COMPOSITE VANE FOR AN AIRCRAFT ENGINE

(71) Applicant: SAFRAN, Paris (FR)

(72) Inventors: Maxime Marie Desire BLAISE, Moissy-Cramayel (FR); Pierre-Antoine BOSSAN, Moissy-Cramayel (FR); Nicolas DROZ, Moissy-Cramayel (FR); Nicolas QUAGLIA, Moissy-Cramayel (FR); Christophe RAVEY, Moissy-Cramayel (FR)

(21) Appl. No.: 18/709,431

(22) PCT Filed: Nov. 15, 2022
(86) PCT No.: PCT/FR2022/052089

§ 371 Date: May 10, 2024

(30) Foreign Application Priority Data
Nov. 18, 2021 (FR) 2112183

(51) Int. Cl. B29C 70/02; B29K 63/00; B29K 105/08; B29K 307/04; B29K 705/00; B29L 31/08

(52) U.S. Cl. CPC B29C 70/023; B29K 2063/00; B29K 2105/0845; B29K 2307/04; B29K 2705/00; B29L 2031/082

(57) ABSTRACT

Method for manufacturing a blade made of a composite material for a turbomachine, in particular of an aircraft, including steps of: a) arranging a preform produced by three-dimensional weaving of fibres within a mould, a polymerisable adhesive being inserted between a shield and an edge of the preform, b) closing and heating the mould, then injecting the polymerisable resin into the mould, wherein the mould is heated according to a cycle including increases in temperature from T1 to T2, then from T2 to T3, and in that the resin is injected in step b) during or just before the increase in temperature from T2 to T3, the temperature T2 being selected so that the viscosity of the adhesive is greater than the viscosity of the resin.

### TECHNICAL FIELD OF THE INVENTION

This invention relates to a method for manufacturing a composite material vane for an aircraft turbomachine.

### TECHNICAL BACKGROUND

The prior art comprises in particular the documents FR-A1-2 956 057, FR-A1-3 029 134, FR-A1-3 051 386, US-A1-2021/324747 and FR-A1-3 081 758.

The use of composite materials is advantageous in the aeronautical industry in particular because these materials have interesting mechanical performances for relatively low masses.

One method for manufacturing a composite part for the aeronautical industry, which is well known to the person skilled in the art, is the moulding method RTM, the initials of which refer to the acronym Resin Transfer Molding.

This is a method for manufacturing a composite material part based on resin-impregnated fibres. Such a method is used, for example, to manufacture a fan vane and comprises several successive steps.

First, the fibres are woven together to obtain a three-dimensional preform blank, and then the blank is cut to obtain a preform having substantially the shape of the vane to be obtained. This preform is then placed in an injection mould, which is closed. Then the resin is injected in a liquid state by maintaining a pressure on the injected resin while the part is polymerized by heating.

The resins used are very fluid resins that are able to penetrate the fibres of the preform well, even when injected under a reduced pressure. During the polymerization, under the effect of the heat, the injected resin passes successively from the liquid state to the gelled state and finally to the solid state.

For the manufacturing of a vane, for example for a turbomachine fan, a preform is produced by weaving and then impregnated with the resin so as to form a blade. This blade comprises a pressure side and a suction side that extend from a leading edge to a trailing edge of the blade.

The composite material of the blade is relatively fragile, and in particular sensitive to the shocks, and it is known to protect it by means of a metal shield which is fitted and attached on the leading edge of the blade.

The shield can be attached to the blade in several ways. A first way consists in gluing the shield to the blade, after polymerization of the resin. The adhesive then takes the form of a paste or of a film.

In current technology, the pairing of the shields to the edges of the vanes is a key and restrictive step in the manufacturing process. The shields are very complex parts and can vary from one to another depending on the manufacturer and manufacturing tolerances, and can therefore have different geometric particularities.

Before pairing and gluing a shield to the edge of a vane, it is therefore necessary to ensure that the dimensions and shape of the shield match those of the vane in order to optimise the gluing surface and therefore the material health of the part once glued (adhesive thickness, porosity rate, etc.).

By doing away with the gluing step and integrating it directly into the injection step, the geometry of the gluing interface can be directly matched to the geometry of the edge of the vane at every point, eliminating the need to find the optimum shield/edge pairing of the vane. This also allows to eliminate the need to prepare the vane surface prior to gluing. Lastly, this allows to eliminate the need for additional heat treatment equipment (oven, autoclave, etc.).

Another way of attaching a shield to a blade has already been proposed, which involves attaching the shield by co-moulding with the fibre preform. The adhesive is placed between the shield and the preform and the assembly is placed in the mould. The injected resin impregnates the preform and a polymerisation step allows to ensure that the adhesive and the resin are polymerised and hardened.

However, this way of doing things gives rise to a number of technical problems:
1. ensuring an optimum gluing of the shield by the adhesive, with the resin being injected and polymerised at the same time: (i) polymerising the adhesive in a time/temperature range that gives the right tack/viscosity and the minimum advancement in the polymerisation rate of the adhesive, (ii) the adhesive's heat treatment temperature be within the recommended range (above its glass transition temperature, Tg), and (iii) polymerising the adhesive and injecting the resin in a production environment and not just in the laboratory;
2. ensuring that the resin and the adhesive are in good material condition (porosity, Tg, resin feed rate, mechanical strength of the adhesive) to ensure the mechanical properties of the composite; to achieve this, it is necessary to: (i) define a resin polymerisation cycle compatible with the adhesive polymerisation cycle, and (ii) be able to pressurise the mould with the lowest possible resin and adhesive feed rate to avoid the chemical porosities; and
3. controlling the depth of diffusion of the adhesive in the preform; to achieve this, a resin injection cycle must be defined within a time/temperature range that allows to ensure that the resin does not alter or creep the adhesive or mix the adhesive uncontrollably.

The present invention is an improvement on the alternative method described above for manufacturing a composite vane, providing a solution to at least some of the problems described above.

### SUMMARY OF THE INVENTION

The invention proposes a method for manufacturing a vane made of a composite material for a turbomachine, in particular for an aircraft, this vane comprising a blade comprising a pressure side and a suction side which extend from a leading edge to a trailing edge of the blade, the vane further comprising a metal shield extending along the leading edge of the blade, the method comprising the steps consisting in:

a) arranging a preform produced by three-dimensional fibre weaving in a mould, the shield being positioned on an edge of the preform intended to form the leading edge of the blade, and a polymerizable adhesive being interposed between the shield and the edge of the preform,

b) closing the mould and heat it, then injecting polymerizable resin into the mould so that it impregnates the preform so as to form the blade after solidification,
characterised in that the mould is heated in a cycle comprising:
   an initial temperature rise from a temperature T1 to a temperature T2,
   possibly a first temperature maintenance stage T2 for a predetermined period,
   a second temperature rise from the temperature T2 to a temperature T3, and
   a second temperature maintenance stage T3 for a predetermined period, and in that:
   the resin is injected in step b) during the second temperature rise, or just before this second temperature rise, and
   the temperature T2 is chosen so that Vc>K.Vr at this temperature, Vc being the viscosity of the adhesive, Vr being the viscosity of the resin, and K being a factor greater than or equal to 100.

The invention thus proposes to ensure the attachment of the shield to the blade by co-moulding and using an adhesive. The adhesive is interposed between the shield and the edge of the preform and can be applied to the shield or directly to the edge of the vane, before the shield is applied to this edge. The adhesive is intended to improve and maintain the position of the shield on the edge of the preform, and also to improve the hold and tear strength of the shield with respect to the blade. When resin is injected into the blade manufacturing mould, this resin will impregnate the preform and will also come into contact with the adhesive or even the shield, thus ensuring an optimum attachment of the shield to the vane.

The invention proposes a particular mould heating cycle that meets at least some of the technical problems mentioned above.

One of the special characteristic of this cycle is that it comprises successive temperature rises and at least one stage. The first stage is optional. In the absence of this first stage, it is understood that the resin is injected when the mould is at temperature T2, whether or not there is a first stage at this temperature, or when the mould is at a temperature between T2 and T3.

The injection of the resin in step b) takes place (during or just before the second temperature rise) at a temperature which may be relatively low (compared with the polymerisation or glass transition temperature of the adhesive) so that the adhesive does not polymerise before injection of the resin begins. On the other hand, the lower the mould temperature, the longer it can take to start injection, giving much greater flexibility in production.

One of the aims of the invention is to inject the resin at the most appropriate moment during this cycle, and in particular when the mould is at a temperature (greater than or equal to T2) at which the viscosities of the resin and of the adhesive are very different. At this temperature, the viscosity of the adhesive is much higher than that of the resin. The resin injected into the mould and which comes into contact with the adhesive therefore runs no risk of mixing with it and displacing it. This allows two distinct phases (of the resin and of the adhesive, respectively) to be kept well defined, of controlled thickness and repeatable during the injection of the resin. At the interface between the resin and the adhesive, however, a mixture of these materials can occur and form an interphase. The temperature of the resin affects its viscosity and is adapted so that the resin can impregnate the assembly of the preform before the heating cycle continues.

The heating cycle thus defines a compromise that takes into account the constraints of each chemical species involved in the proper gluing of a shield to the edge of a vane.

The method according to the invention may comprise one or more of the following characteristics, taken alone or in combination with each other:
the resin injection takes place at the end of the stage at temperature T2;
T2 is between 50 and 150° C., preferably between 80 and 120° C., and more preferably between 90 and 110° C.;
the first temperature rise is preferably chosen so as not to alter the properties of the adhesive, and is for example between 1 and 10°° C. per minute, preferably between 1 and 5° C. per minute, and more preferably between 2 and 3° C. per minute; this choice can be made according to the specific specificities of the adhesive detailed in the technical data sheet supplied by the adhesive supplier;
the temperature T1 is an ambient temperature;
the injection begins at the start of the second temperature rise;
the injection begins after the start of the second temperature rise; this therefore constitutes a variant; two heating cycles are thus proposed;
K is greater than or equal to 300, for example between 300 and 1500;
the duration of the first stage is between 30 minutes and 2 hours; this duration can be chosen to ensure that the mould has a homogeneous temperature;
the resin is preheated to a temperature Tr before it is injected in step b); preheating the resin can have a double effect; preheating the resin, for example in an injection cylinder, to a temperature of between 100° C. and 130° C., allows to reduce the viscosity of the resin and therefore allows it to be injected; preheating the resin, for example in a heating element (typically an external preheater, but can be performed by an air gap in the mould), to a temperature above 160° C., allows to melt a curing agent and activate the latter; in fact, the resin comprises a curing agent which must be dissolved by heating in the resin before it is injected into the mould; the dissolution of the curing agent in the mould after injection of the resin might not be complete if it were obtained by simply heating the resin through the mould;
the temperature Tr is higher than the temperature T2, and is for example higher than or equal to 100° C., preferably higher than or equal to 130° C., and more preferably higher than or equal to 160° C.;
T3 is greater than or equal to 140° C., preferably greater than or equal to 150° C., and more preferably greater than or equal to 160° C.;
the duration of the second stage is between 10 minutes and 1 hour, preferably between 20 and 40 minutes, and more preferably 30 minutes; this value can depend on the application envisaged for the vane and in particular on the effects of mass due to the shape (thickness) of the vane; this stage can be considered as a pressure maintenance stage because the resin can continue to be injected at a certain pressure in order to maintain the resin-injected preform under a given pressure necessary to avoid the appearance of bubbles and therefore porosity in the composite vane;
the cycle also comprises:
   a third temperature rise from the temperature T3 to a temperature T4, and
   a third maintenance stage of temperature T4 for a predetermined period of time;
the temperature T4 is higher than the glass transition temperatures of the resin and of the adhesive, and is for example greater than or equal to 160° C., preferably greater than or equal to 170° C., and more preferably greater than or equal to 180° C.;
the duration of the third stage is between 1 hour and 3 hours, and preferably between 1.5 hours and 2.5 hours; this stage can be considered as a polymerisation or polymerisation stage for the vane;
the shield or another shield extends along the trailing edge of the blade, and/or along a top of the blade;
the vane is an OGV, an acronym for Outer Guide Vane.

### BRIEF DESCRIPTION OF THE FIGURES

Further characteristics and advantages of the invention will become apparent from the following detailed description, for the understanding of which reference is made to the attached drawings in which:

FIG. 1 is a schematic perspective view of a composite aircraft turbomachine vane,

FIG. 2 is a block diagram showing steps of a method according to the invention for manufacturing a vane such as that shown in FIG. 1,

FIG. 3 is a schematic perspective view of a mould in which a preform and a shield are intended to be arranged, and into which a resin is intended to be injected,

FIG. 4 is a graph representing a heating cycle for a mould used to manufacture a vane as shown in FIG. 1, and illustrates two alternative embodiments of the invention,

FIG. 5 is a graph showing the evolution of the viscosity of a polymerizable resin as a function of the time and temperature at which the resin is heated.

### DETAILED DESCRIPTION OF THE INVENTION

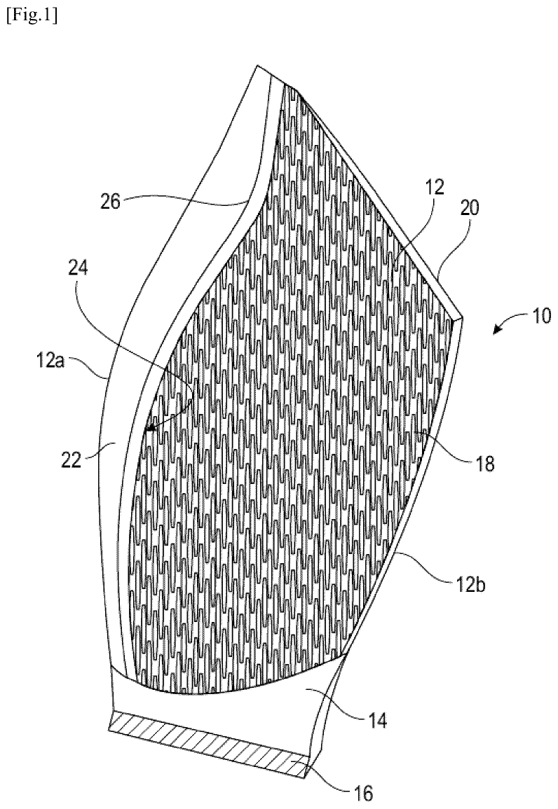

FIG. 1 illustrates a composite material vane 10 for a turbomachine, this vane 10 being, for example, a fan vane or a vane of stator vane for a secondary flow in the case of a turbofan engine.

The vane 10 comprises a blade 12 connected by a stilt 14 to a root 16 which has, for example, a dovetail shape and is shaped to be engaged in a complementarily shaped slot of a rotor disk, in order to retain the vane on this disk.

The blade 12 comprises a leading edge 12a and a trailing edge 12b of the gases flowing through the turbomachine. The blade 12 has a curved or twisted aerodynamic profile and comprises a pressure side 18 and a suction side 20 extending between the leading 12a and trailing 12b edges.

The blade 12 is produced from a fibrous preform obtained by three-dimensional weaving of fibres, for example carbon.

The leading edge 12a of the blade is reinforced and protected by a metal shield 22 that is attached to this leading edge 12a. This shield or another shield could extend along the trailing edge of the blade and/or along the top of the blade. The shield 22 is made, for example, of a nickel-and cobalt-based alloy, titanium, stainless steel, etc.

In the present invention, this attachment is achieved on the one hand by co-moulding the preform with the shield 22, and on the other hand by gluing the shield 22 by means of an adhesive 26.

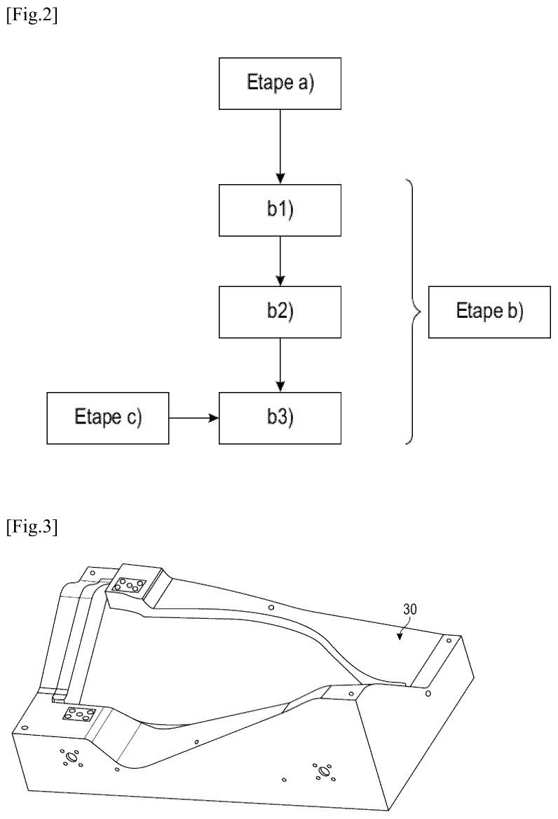

FIG. 2 is a flowchart that illustrates steps in a method for manufacturing a composite vane 10 such as the one shown in FIG. 1.

The method may comprise several steps, some of which are optional.

The first step a) of the method comprises producing a fibrous preform by weaving fibres, preferably in three dimensions, using a Jacquard-type weaving machine for example. The resulting preform is raw and can undergo operations such as cutting or compression. The first step a) also comprises depositing adhesive between the shield 22 and the edge of the preform 24 and then placing the assembly thus obtained in a mould 30 for manufacturing the vane, which is shown in FIG. 3. The adhesive 26 can be applied by brush or by means of a spray, for example. Alternatively, it can take the form of a tab. Preferably, the adhesive is in the form of an adhesive film (such as a pre-impregnated fabric) which is cut to the desired shape and then applied to the leading edge by the operator before the shield is paired with the leading edge.

The adhesive is, for example, that marketed by 3M® under the reference AF191. This is a film adhesive consisting of a braided backing impregnated with an epoxy-based thermosetting resin.

The shield 22 is generally dihedral in shape and defines a groove with V-shaped cross-section into which an edge of the preform is inserted. The adhesive 26 can be deposited in the groove of the shield and/or on the edge of the preform 24.

The preform 24 equipped with the adhesive 26 and the shield 22 is then placed in the mould 30 (FIG. 3).

In step b), the mould is closed (sub-step b1), for example with a counter-mould fitted to the mould 30.

The mould 30 is then heated using a predefined heating cycle in accordance with the invention (sub-step b2).

During this cycle, a polymerizable resin is injected (sub-step b3) and this resin is preferably heated (step c) prior to injection, as will be explained in more detail below.

The resin injected into the mould 30 is intended to impregnate the preform 24 and come into contact with the adhesive 26 of the shield 22. Once the resin has polymerised and hardened, the shield 22 is secured to the blade by means of the adhesive 26 and the resin.

The vane 10 thus obtained, after polymerization of the resin, is advantageous in that its shield 22 is perfectly positioned and maintained on the blade 12.

The resin is, for example, that marketed by Solvay under the reference PR520. This is an epoxy-based thermosetting resin comprising a curing agent referred to as CAF, this curing agent being in the form of particles mixed with the base and intended to be dissolved by heating. Alternatively, the resin could be that marketed by 3M® under the reference 2894.

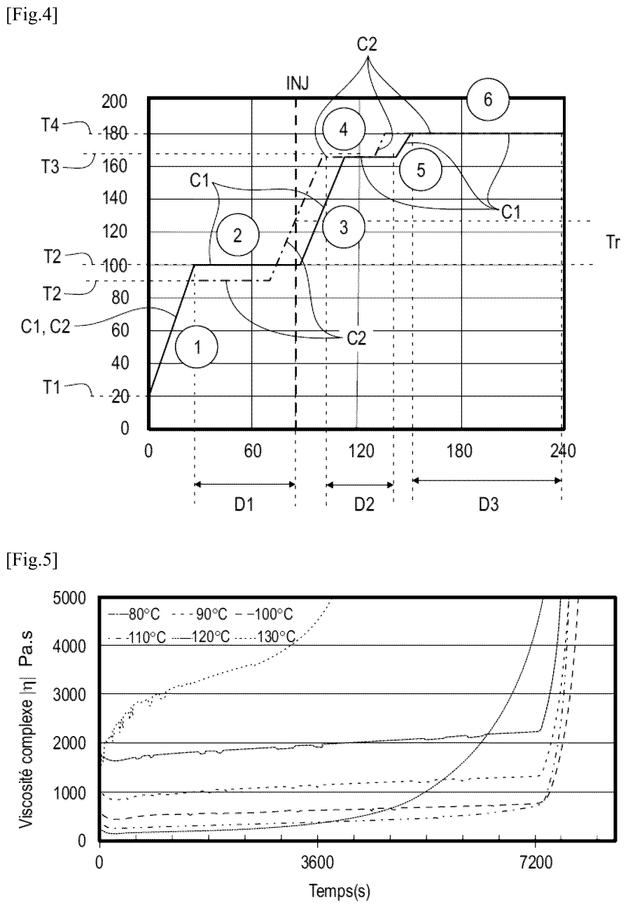

FIG. 4 illustrates a characteristic of the invention relating to the time of injection of the resin into the mould.

FIG. 4 is a graph showing two different embodiments of a mould heating cycle, showing the evolution of the temperature of the mould as a function of time.

The y-axis therefore represents the temperature in degrees Celsius, which in this case ranges from 0 to 200° C. The x-axis represents the time or the duration in minutes, ranging from 0 to 240 min in the example shown.

A first cycle is designated by the reference C1 and is represented by continuous lines. The second cycle is referred to as C2 and is represented by dotted lines.

According to the invention, each of the cycles C1, C2 comprises a succession of temperature rises and stages, preferably at least two of each and more preferably three of each as in the example shown.

Each cycle comprises:
an initial temperature rise from a temperature T1 to a temperature T2,
possibly a first maintenance stage of temperature T2 for a predetermined period D1,
a second temperature rise from the temperature T2 to a temperature T3, and:
a second temperature maintenance stage T3 for a predetermined period D2,
possibly a third temperature rise from the temperature T3 to a temperature T4, and
possibly a third maintenance stage of temperature T4 for a predetermined period D3.

FIG. 1 also shows the start of resin injection into the mould with a dashed line. This line is referenced INJ. We can see that this injection takes place during the second temperature rise or just before this second temperature rise. More precisely, in the example shown, the injection begins at the end of the stage at the temperature T2, i.e. just before the start of the second temperature rise as part of the first cycle C1, and therefore at the temperature T2 of the mould, or after the start of this injection as part of the second cycle C2, when the mould temperature is between T2 and T3.

According to another characteristic of the invention, the temperature T2 is chosen so that Vc>K.Vr at this temperature, with:
Vc: the viscosity of the adhesive,
Vr: the viscosity of the resin, and
K: a factor greater than or equal to 100.

In the following, general information is first given about the different parameters of the heating cycle of the manufacturing method. These parameters are valid for several resin-adhesive pairs and a particular case of implementation of this cycle will be described in more detail in the case of a resin PR520 and adhesive AF191 pair (which is comparable to the resin 2894 and adhesive AF191 pair).

General information on the heating cycle according to a preferred embodiment of the invention:

T2 is between 50 and 150° C., preferably between 80 and 120° C., and more preferably between 90 and 110° C.

The first temperature rise is chosen so as not to alter the properties of the adhesive, and is for example between 1 and 10° C. per minute, preferably between 1 and 5° C. per minute, and more preferably between 2 and 3° C. per minute.

The temperature T1 is an ambient temperature.

K is preferably greater than or equal to 300.

The duration D1 of the first stage is between 30 minutes and 2 hours.

The resin is preheated to a temperature of Tr before being injected in step b). This temperature Tr is higher than the temperature T2, and is for example greater than or equal to 100° C., preferably greater than or equal to 130° C., and more preferably greater than or equal to 160° C.

T3 is greater than or equal to 140° C., preferably greater than or equal to 150° C., and more preferably greater than or equal to 160 ° C.

The duration D2 of the second stage is between 10 minutes and 1 hour, preferably between 20 and 40 minutes, and more preferably 30 minutes.

The temperature T4 is higher than the glass transition temperatures of the resin and the adhesive, and is for example greater than or equal to 160° C., preferably greater than or equal to 170°° C., and more preferably greater than or equal to 180° C.

The duration D3 of the third stage is between 1 and 3 hours, preferably between 1.5 and 2.5 hours.

Specific example of the resin PR520 and adhesive AF191 pairing (comparable to the resin 2894 and adhesive AF191 pairing)

The resin PR520 must first be injected at a temperature of at least 160° C. to allow to dissolve its curing agent and reduce the viscosity of the resin. Without this dissolution, it can be difficult to lower the temperature of the mould and the resin injection press.

With reference to the circled number 1 in FIG. 1 and the first temperature rise from T1 to T2:
the temperature rise in the cavity of the mould is set at 2.5° C./min, in accordance with the recommendations contained in the technical data sheet of the adhesive;
the starting point is the most suitable temperature for applying the adhesive, typically room temperature.

With reference to the circled number 2 in FIG. 1 and to the first stage at temperature T2:
the lower limit of the injection temperature is defined by the viscosity of the adhesive (in this case, AF191); the higher the temperature, the more the adhesive will react even before the injection has begun; however, a pressure must be transmitted as long as possible and before the gel point of the adhesive to avoid the porosity within the adhesive seal; FIG. 5 shows the results of laboratory viscosity tests, which demonstrate the influence of the temperature at different isotherms on the viscosity of the adhesive AF191; it can be seen that up to 100° C., the resin reacts very little over a 2-hour stage; it only starts to react at the end of the stage for a stage of 110° C.; a stage temperature ≤100° C. is recommended because a time of 2 hours seems sufficient to manage production contingencies and provide sufficient flexibility in the method; a longer or even shorter duration could be demonstrated depending on the need;
the upper limit of the injection temperature is defined by the viscosity of the resin (here, PR520); in fact, the lower the temperature, the higher the viscosity of the resin, to the point of not being able to inject the resin into the preform due to excessive pressure drops with injectors that can control flow rate with a maximum pressure of 30 bars in general.

According to the recommendations of the supplier of the resin PR520, the viscosity during the injection should not rise above 0.5 Pa·s. On the basis of tests on parts (vanes) and simulation, the pressure drops at 90° C. are not limiting for the injection at an injection pressure compatible with standard equipment and the material health of the part. A stage temperature ≥90° C. is therefore recommended in this case.

Laboratory viscosity tests show the influence of temperature at different isotherms on the viscosity of the resin PR520. It can be seen that the average viscosity in the first 20 minutes of the isotherm (average duration of an RTM injection for a vane) changes as follows:
100° C.: 0.7 Pa·s;
90° C.: 1.5 Pa·s;
80° C.: 5 Pa·s;

Given these results, a compromise temperature or injection stage is around 90 to 110° C. This compromise allows:
ensure that the viscosity of the resin PR520 is low enough to be injected;
ensure that the viscosity of the adhesive AF191 is high enough to remain in position on the preform as the mould rises in temperature, limit its creep and therefore ensure a controlled and repeatable adhesive interface. In addition, at this temperature, there is a factor of 300 to 1500 between the viscosity of the adhesive (500 to 1000 Pa·s) and that of the resin (1.5 to 0.7 Pa·s), ensuring a limited mixing of the two compounds and a control of the interface.
ensure a 2-hour injection window during which the quality of the gluing interface remains constant, since the viscosity of the adhesive changes very little. This injection window ensures a flexibility in production, for example:
the correct mould temperature;
a minimum temperature of the resin before injection (viscosity, curing agent dissolution);
a level of vacuum in the hot mould, level of loss of vacuum in the hot mould;
an availability of the operators;
a proper operation of the injection moulding machine;
a correct connection of the mould thermocouples;
a proper operation of the resin heater;

etc.

Even if we imagine a fully automated injection (no need for an operator to start the injection), this flexibility allows to ensure that all the pre-injection conditions are met and avoids damaging the preform as the adhesive deposited on the preform in the mould begins to polymerise.

The maximum duration of the stage is 2 hours. In fact, you don't need to wait 2 hours before starting the injection. The only constraints are:
to achieve a sufficient thermal homogeneity of the mould; this parameter is left to the discretion of each person, but the person skilled in the art will set it at ±10 to ±1° C. depending on the requirements of the part (in particular its geometry);
limited in this case to 2 h, determined by the absence of the adhesive reaction observed in FIG. 5 for the stages of 80, 90 and 100° C. (it would obviously be possible to push this limit by continuing the viscosity tests for a longer period).

As far as the injection of the resin is concerned, it can be difficult or even impossible to inject the resin into the stage at 90° C. Two variants are possible.

a) Injection starts at the end of the 90° C. stage (curve C2) and at the start of the second temperature rise:
this is made possible by taking into account the thermal response time of the mould in relation to the injection moulding machine. A thermal map of the mould is used to define the response time required for the mould cavity to respond when heating of the press is initiated;
advantages: the temperature of the adhesive during the stage is minimised and therefore the stage time can only be longer;
disadvantages: the injection takes place in a thermal transient; the response of the mould therefore depends on parameters such as the reactivity and the capacity of the injection moulding machine, which are not easy to control and reproduce accurately in series production.

b) the injection begins at the end of the 100° C. stage (curve C1) and at the start of the second temperature rise.
advantages: the isothermal injection is much easier to control in production than in transient conditions; the repeatability and the reproducibility are increased; for this reason, this solution is to be preferred in an industrial setting;
disadvantages: the adhesive is maintained at a higher temperature, limiting the possible duration of the stage and, in principle, slightly degrading the quality of the adhesive due to the greater creep of the adhesive.

The curing agent of the resin PR520 is activated at a temperature of at least 160° C., as explained by the supplier of the resin PR520 in its technical data sheet. It is therefore necessary to dissolve the curing agent completely before the resin arrives in the mould, where the temperature is relatively low (<160° C.). The curing agent can be dissolved by passing it through a heater located at the mould inlet, ensuring that the curing agent is completely dissolved before the resin enters the injection mould.

The dissolving the curing agent also allows to reduce the viscosity of the resin. It is difficult, if not impossible, to inject the resin PR520 into a mould at less than 160° C. if the curing agent has not been dissolved beforehand.

With reference to the circled number 3 in FIG. 4 and the second temperature rise from T2 to T3:

At this step, the resin and the adhesive coexist in the mould and the characteristics of the temperature rise can have an impact on the following parameters in particular:
porosity: it has been shown in production that the temperature rise can have an impact on the rate of porosity;
thermal uniformity of the mould: the faster the temperature rises, the less uniform the temperature of the mould and potentially the more residual stresses the part will have; all the more so in the adhesive seal where a composite part is joined to a metal part

With reference to the number 4 circled in FIG. 1 and the second stage at temperature T3, referred to as the pressure maintenance stage:
the resin pressure maintenance stage may be necessary, depending on the geometry of the part, to ensure an acceptable rate of porosity in the resin PR520; this is the case in the context of the present invention for the manufacture of a vane; the temperature T3 of the stage may be around 160° C.; one of the principles is to aim for the temperature at which the viscosity of the resin is the lowest in order to allow the maximum transmission of pressure and therefore close the porosities already created or in the process of being created (gas emissions during polymerisation);
in this case, the duration of the stage is approximately 30 minutes; this duration is defined in order to minimise the rate of porosity in the vane.

With reference to the circled number 5 in FIG. 4 and the third temperature rise from T3 to T4, the conditions and parameters are similar to the second temperature rise.

With reference to the circled number 6 in FIG. 4 and the third stage at temperature T4, referred to as the baking stage:
this stage consists of the final polymerisation of the resin and of the adhesive to reach their respective glass transition temperatures Tg; the temperature must therefore be compatible with the two chemical species; this may also be a selection parameter for these two elements; in this case, a 2-hour stage at 180° C., as recommended by the supplier of the resin PR520, is selected; the supplier of the adhesive AF191 recommends a 60-minute polymerisation stage at 176°° C. (350° F.), although a polymerisation from 135 to 205° C. (275-400° F.) is also possible.

1. A method for manufacturing a vane made of a composite material for a turbomachine, in particular for an aircraft, this vane comprising a blade comprising a pressure side and a suction side which extend from a leading edge to a trailing edge of the blade, the vane further comprising a metal shield extending along the leading edge of the blade, the method comprising the steps consisting in:
a) arranging a preform produced by three-dimensional fibre weaving in a mould, the shield being positioned on an edge of the preform intended to form the leading edge of the blade, and a polymerizable adhesive being interposed between the shield and the edge of the preform,
b) closing the mould and heating it, then injecting the polymerizable resin into the mould so that it impregnates the preform so as to form the blade after solidification, wherein the mould is heated in a cycle comprising:
an initial temperature rise from a temperature T1 to a temperature T2,
possibly a first temperature maintenance stage T2 for a predetermined period,
a second temperature rise from the temperature T2 to a temperature T3, and
a second temperature maintenance stage T3 for a predetermined period,
and in that:
the resin is injected in step b) during the second temperature rise, or just before this second temperature rise, and
the temperature T2 is chosen so that Vc>K.Vr at this temperature, Vc being the viscosity of the adhesive, Vr being the viscosity of the resin, and K being a factor greater than or equal to 100.

2. The method according to claim 1, wherein T2 is between 50 and 150° C., preferably between 80 and 120° C., and more preferably between 90 and 110° C.

3. The method according to claim 1, wherein the first temperature rise is between 1 and 10° C. per minute, preferably between 1 and 5° C. per minute, and more preferably between 2 and 3° C. per minute.

4. The method according to claim 1, wherein the temperature T1 is an ambient temperature.

5. The method according to claim 1, wherein the injection begins at the start of the second temperature rise.

6. The method according to claim 1, wherein the injection begins after the start of the second temperature rise.

7. The method according to claim 1, wherein K is greater than or equal to 300.

8. The method according to claim 1, wherein the duration of the first stage is between 30 minutes and 2 hours.

9. The method according to claim 1, wherein the resin is preheated to a temperature Tr before being its injection in step b).

10. The method according to claim 9, wherein the temperature Tr is greater than the temperature T2, and is for example greater than or equal to 100° C., preferably greater than or equal to 130° C., and more preferably greater than or equal to 160° C.

11. The method according to claim 1, wherein T3 is greater than or equal to 140° C., preferably greater than or equal to 150° C., and more preferably greater than or equal to 160° C.

12. The method according to claim 1, wherein the duration of the second stage is between 10 minutes and 1 hour, preferably between 20and 40 minutes, and more preferably 30 minutes.

13. The method according to claim 1, wherein the cycle further comprises:
a third temperature rise from the temperature T3 to a temperature T4, and
a third maintenance stage of temperature T4 for a predetermined period.

14. The method according to claim 13, wherein the temperature T4 is higher than the glass transition temperatures of the resin and of the adhesive, and is for example greater than or equal to 160° C., preferably greater than or equal to 170° C., and more preferably greater than or equal to 180° C.

15. The method according to claim 13, wherein the duration of the third stage is between 1 hour and 3 hours, and preferably between 1.5 hours and 2.5 hours.
